(19) United States
(12) Patent Application Publication
(10) Pub. No.: US 2024/0409437 A1
(43) Pub. Date: Dec. 12, 2024

(54) WATER PURIFIER

(71) Applicant: COWAY CO., LTD., Gongju-si (KR)

(72) Inventors: Hee Joo KANG, Gongju-si (KR); Hee do JUNG, Gongju-si (KR); Jong Hwan LEE, Gongju-si (KR); Hyun Kang LEE, Gongju-si (KR); Byung Hyo YE, Gongju-si (KR); Dong Min OH, Gongju-si (KR); Seung Won LEE, Gongju-si (KR); Seong Min PARK, Gongju-si (KR)

(73) Assignee: COWAY CO., LTD., Gongju-si (KR)

(21) Appl. No.: 18/700,970

(22) PCT Filed: Sep. 22, 2022
(86) PCT No.: PCT/KR2022/014196

§ 371 Date: Apr. 12, 2024

(30) Foreign Application Priority Data
Oct. 15, 2021 (KR) 10-2021-0137616

(51) Int. Cl. C02F 1/00; B67D 1/00; B67D 1/08

(52) U.S. Cl. CPC C02F 1/003; B67D 1/0014; B67D 1/08

(57) ABSTRACT

The present disclosure provides a water purifier including: a main body having a purified water outlet through which purified water is dispensed, a cold water outlet through which cold water is dispensed, and a hot water outlet through which hot water is dispensed; a first flow path module coupled to be attachable to and detachable from the main body and having a purified water dispensing pipe connected to the purified water outlet and a cold water dispensing pipe connected to the cold water outlet; and a second flow path module coupled to be attachable to and detachable from the main body and having a hot water dispensing pipe connected to the hot water outlet, wherein, when an external force of a predetermined value or more is applied in a first direction, coupling of the first and second flow path modules to the main body is fixed, and when the external force of the predetermined value or more is applied in a second direction, the coupling of the first and second flow path modules to the main body is released.

### TECHNICAL FIELD

The present disclosure relates to a water purifier, and more particularly, to a water purifier that can provide cold water and hot water by cooling or heating purified water generated by filtering raw water.

### BACKGROUND ART

Water dispensing flow paths of conventional water purifiers have a structure that is fixed to the product, and generally, a separate tool is required to detach and replace a water dispensing flow path. Accordingly, for hygiene management of water purifiers through replacement of water dispensing flow paths, experts have to visit users' houses or workplaces where water purifiers are installed and provide services. However, in recent years, with an increase in social demand for non-contact self-management, a need for development of a structure that allows a user to replace a water dispensing flow path of a water purifier without assistance has increased.

Korean Patent Registration No. 1957684 of Coway Co., Ltd. discloses a water purifying filter assembly module and a water purifier having the same. The water purifier of such a structure has a feature in which, in relation to hygiene management of the water purifier, replacement of a water purifying filter is possible in a narrow space. However, the water purifier does not provide a structure that allows a user to replace and manage only a purified water dispensing flow path or a cold/hot water dispensing flow path instead of the entire filter without assistance.

Also, Korean Patent Registration No. 1696216 of Coway Co., Ltd. discloses a water purifier having an ice maker in which it is easy to detach a purified water tank, clean the inside of the water purifier having the ice maker, and replace parts. Such a water purifier provides a structure that facilitates replacement and cleaning of parts related to ice making but does not provide a structure that allows a user to replace and manage a purified water dispensing flow path or a cold/hot water dispensing flow path without assistance.
(Patent Document 1) Korean Patent Registration No. 1957684
(Patent Document 2) Korean Patent Registration No. 1696216

### DISCLOSURE

### Technical Problem

The present disclosure is directed to a water purifier that allows a user to easily replace a water dispensing flow path of the water purifier without assistance and without using a separate tool.

One embodiment of the present disclosure is directed to a water purifier in which flow paths to be replaced are configured as modules for the flow paths to be efficiently replaced in modular units.

One embodiment of the present disclosure is directed to a water purifier in which flow path modules are configured as attachable/detachable cartridges to improve the ease of replacement of flow paths.

One embodiment of the present disclosure is directed to a water purifier that provides cold water and also enables replacement of a cold water inlet pipe to improve hygiene related to cold water.

One embodiment of the present disclosure is directed to a water purifier that effectively achieves connection and sealing of pipes at the time of attachment and detachment of flow path modules.

One embodiment of the present disclosure is directed to a water purifier that allows various water dispensing flow paths and faucets to be integrally replaced to improve the ease of management and hygiene.

### Technical Solution

The present disclosure provides a water purifier including: a main body configured to filter raw water to generate purified water, cool the purified water to generate cold water, and heat the purified water to generate hot water and having a purified water outlet through which the purified water is dispensed, a cold water outlet through which the cold water is dispensed, and a hot water outlet through which the hot water is dispensed: a first flow path module coupled to be attachable to and detachable from the main body and having a purified water dispensing pipe connected to the purified water outlet and a cold water dispensing pipe connected to the cold water outlet; and a second flow path module coupled to be attachable to and detachable from the main body and having a hot water dispensing pipe connected to the hot water outlet, wherein, when an external force of a predetermined value or more is applied to the first flow path module in a first direction, as the first flow path module is coupled and fixed to the main body, the purified water outlet and the cold water outlet are connected to the purified water dispensing pipe and the cold water dispensing pipe, respectively, when the external force of the predetermined value or more is applied to the first flow path module in a second direction different from the first direction, as coupling between the first flow path module and the main body is released, connection between the purified water outlet and the purified water dispensing pipe and connection between the cold water outlet and the cold water dispensing pipe are released, when the external force of the predetermined value or more is applied to the second flow path module in the first direction, as the second flow path module is coupled and fixed to the main body, the hot water dispensing pipe is connected to the hot water outlet, and when the external force of the predetermined value or more is applied to the second flow path module in the second direction, as coupling between the second flow path module and the main body is released, connection between the hot water outlet and the hot water dispensing pipe is released.

In the water purifier according to one embodiment of the present disclosure, the main body may further have a cold water tank in which the purified water is cooled and a cold water inlet through which the purified water heading to the cold water tank is dispensed, and the first flow path module may further have a cold water receiving pipe connected to the cold water inlet when the first flow path module is mounted on the main body.

In the water purifier according to one embodiment of the present disclosure, the purified water outlet, the cold water outlet, and the hot water outlet may be open in an upward direction, and the first flow path module and the second flow path module may enter the main body in a downward direction and be mounted thereon.

In the water purifier according to one embodiment of the present disclosure, the main body may further have an intermediate frame positioned at a predetermined height from an installation surface and on which the purified water outlet, the cold water outlet, and the hot water outlet are disposed and a cover frame disposed at an upper side of the intermediate frame, and the first flow path module and the second flow path module may be mounted on the main body through a first mounting hole and a second mounting hole provided to pass through the cover frame in an up-down direction.

In the water purifier according to one embodiment of the present disclosure, the intermediate frame and the cover frame may be fixed and coupled to the main body.

In the water purifier according to one embodiment of the present disclosure, the first flow path module may further have a first flow path case, the purified water dispensing pipe and the cold water dispensing pipe may be disposed inside the first flow path case, and an end of the purified water dispensing pipe and an end of the cold water dispensing pipe may be exposed through one surface of the first flow path case.

In the water purifier according to one embodiment of the present disclosure, the second flow path module may further have a second flow path case, the hot water dispensing pipe may be disposed inside the second flow path case, and an end of the hot water dispensing pipe may be exposed through one surface of the second flow path case.

In the water purifier according to one embodiment of the present disclosure, the end of each of the purified water outlet, the cold water outlet, and the hot water outlet may be provided as an opening, and a fitting that allows the purified water dispensing pipe to be inserted, seated, and connected, a fitting that allows the cold water dispensing pipe to be inserted, seated, and connected, and a fitting that allows the hot water dispensing pipe to be inserted, seated, and connected may be coupled to the end of the purified water outlet, the end of the cold water outlet, and the end of the hot water outlet, respectively.

### Advantageous Effects

According to the above configuration, a water purifier according to the present disclosure provides an effect of allowing a user to easily replace a water dispensing flow path of the water purifier without assistance and without using a separate tool.

A water purifier according to one embodiment of the present disclosure has flow paths to be replaced configured as modules and provides an effect of allowing the flow paths to be efficiently replaced in modular units.

A water purifier according to one embodiment of the present disclosure has flow path modules configured as attachable/detachable cartridges and provides an effect of improving the ease of replacement of flow paths.

A water purifier according to one embodiment of the present disclosure provides cold water and also enables replacement of a cold water inlet pipe to provide an effect of improving hygiene related to cold water.

A water purifier according to one embodiment of the present disclosure provides an effect of effectively achieving connection and sealing of pipes at the time of attachment and detachment of flow path modules.

A water purifier according to one embodiment of the present disclosure allows various water dispensing flow paths and faucets to be integrally replaced to provide an effect of improving the ease of management and hygiene.

### DESCRIPTION OF DRAWINGS

FIG. 1 is a perspective view of a water purifier according to one embodiment of the present disclosure.

FIG. 2 is a perspective view of a partial configuration of the water purifier according to one embodiment of the present disclosure.

FIG. 3 is an exploded perspective view of the partial configuration of the water purifier according to one embodiment of the present disclosure.

FIG. 4 is a view of FIG. 2 from which a cover frame is omitted.

FIG. 5 is an exploded view of a first flow path module.

FIG. 6 is a perspective view of a coupling state of the first flow path module.

FIG. 7 is an exploded view of a second flow path module.

FIG. 8 is a perspective view of a coupling state of the second flow path module.

FIG. 9 is a longitudinal cross-sectional view illustrating a connection state of an end of a pipe and a fitting.

### MODES OF THE DISCLOSURE

Words or terms used in the specification and the claims should not be interpreted as being limited to their general or dictionary meanings and should be interpreted to have meanings and concepts consistent with the technical spirit of the present disclosure, according to the principle that the inventor may define terms and concepts thereof in order to describe his or her disclosure in the best possible way.

Therefore, the embodiments described in the specification and the configurations illustrated in the drawings are only exemplary embodiments of the present disclosure and do not represent the entire technical spirit of the present disclosure, and thus various equivalents and modifications that can replace the embodiments may be present at the time of filing this application.

In the present specification, terms such as “include” or “have” are intended to describe the presence of features, numbers, steps, operations, components, parts, or combinations thereof mentioned herein and should not be understood as precluding the possibility of presence or addition of one or more other features, numbers, steps, operations, components, parts, or combinations thereof.

When a certain component is described as being “in front of,” “behind,” “above,” or “under” another component, unless there is some special circumstance, this not only includes a case in which the component is disposed right “in front of,” “behind,” “above,” or “under” the other component, but also includes a case in which another component is disposed between the two components. Also, when a certain component is described as being “connected” to another component, unless there is some special circumstance, this not only includes a case in which the component and the other component are directly connected to each other, but also includes a case in which the component and the other component are indirectly connected to each other.

Hereinafter, a water purifier according to embodiments of the present disclosure will be described with reference to the accompanying drawings.

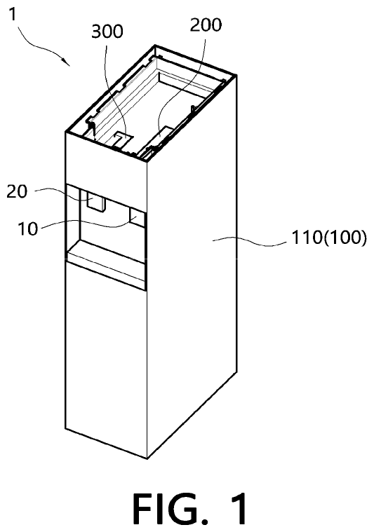

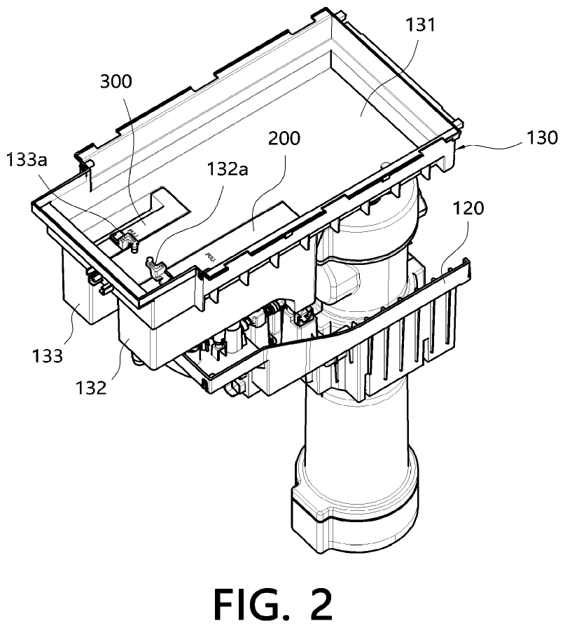

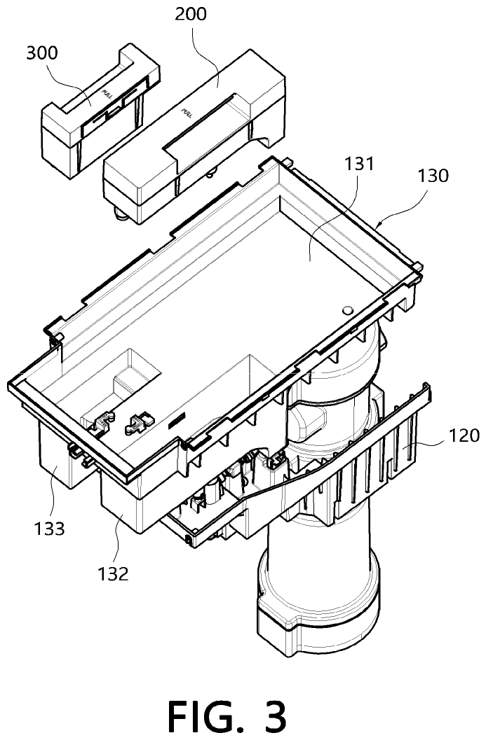

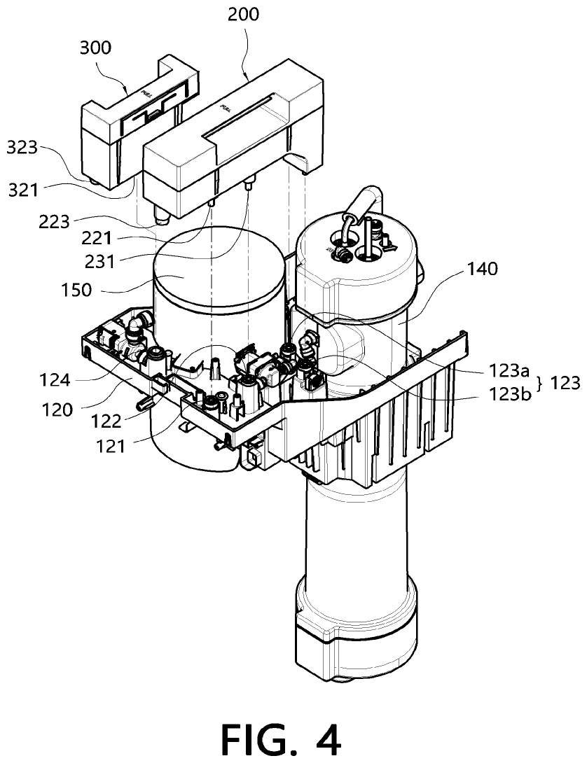

FIG. 1 is a perspective view of a water purifier according to one embodiment of the present disclosure. FIG. 2 is a perspective view of a partial configuration of the water purifier according to one embodiment of the present disclosure, FIG. 3 is an exploded perspective view of the partial configuration of the water purifier according to one embodiment of the present disclosure, and FIG. 4 is a view of FIG. 2 from which a cover frame is omitted.

A water purifier 1 according to one embodiment of the present disclosure filters raw water supplied from the outside and provides purified water. The water purifier 1 according to one embodiment of the present disclosure may be a direct water type water purifier that does not have a storage tank which causes purified water to come in contact with outside air. Also, the water purifier 1 according to one embodiment of the present disclosure may cool or heat purified water to generate and supply cold water and hot water. Referring to FIGS. 1 to 4, the water purifier 1 according to one embodiment of the present disclosure includes a main body 100, a first flow path module 200, and a second flow path module 300.

The main body 100 filters raw water to generate purified water, cools the purified water to generate cold water, and heats the purified water to generate hot water. The main body 100 may have a housing 110 in which configurations for generating the purified water, cold water, and hot water are embedded. That is, the configurations for generating the purified water, cold water, and hot water may be disposed inside the housing 110. Also, a purified/cold water dispenser 10 from which the purified water and cold water are dispensed and a hot water dispenser 20 from which the hot water is dispensed may be provided at a front surface of the housing 110.

The main body 100 has a purified water outlet 121 through which purified water is dispensed, a cold water tank 140, a cold water outlet 122 through which cold water is dispensed, a cold water inlet 123 through which the purified water heading to the cold water tank 140 is dispensed, and a hot water outlet 124 through which hot water is dispensed.

The purified water outlet 121 is provided to dispense purified water generated by filtering raw water. The purified water outlet 121 is connected to a purified water generator (not illustrated) including one or more filters and discharges purified water generated by the purified water generator. The purified water dispensed through the purified water outlet 121 may be discharged to the outside of the water purifier 1 through the purified/cold water dispenser 10 via the first flow path module 200.

The cold water tank 140 accommodates purified water generated by filtering raw water. The cold water tank 140 may have a shape that extends in an up-down direction to accommodate the purified water generated by filtering the raw water. The purified water is cooled to generate cold water in the cold water tank 140. Here, the purified water may be cooled by a refrigerant, and a refrigerant flow path that serves as an evaporator may be disposed inside the cold water tank 140. In relation to cooling the purified water through a refrigerant flow, a compressor that compresses a refrigerant and provides a flow force, a condenser that condenses the refrigerant, an expansion valve, and the like may be disposed inside the housing 110. The purified water may be cooled and generated as cold water while temporarily stagnating or flowing in the cold water tank 140. Also, the cold water tank 140 may have a form that is sealed from outside air and may be disposed in an upright form on the ground. For example, the cold water tank 140 may have a cylindrical shape.

The cold water outlet 122 is provided to dispense cold water generated in the cold water tank 140. The cold water outlet 122 may be connected to a cold water dispensing flow path through which the cold water generated in the cold water tank 140 is discharged. The cold water dispensed through the cold water outlet 122 may be discharged to the outside of the water purifier 1 through the purified/cold water dispenser 10 via the first flow path module 200.

The cold water inlet 123 is provided to dispense purified water introduced into the cold water tank 140. In one embodiment of the present disclosure, the cold water inlet 123 may have a first cold water inlet 123a through which purified water generated by the purified water generator is dispensed and a second cold water inlet 123b through which purified water dispensed through the first cold water inlet 123a and heading toward the cold water tank 140 via the first flow path module 200 is dispensed. The purified water dispensed through the second cold water inlet 123b enters the cold water tank 140 and is generated as cold water.

The hot water outlet 124 is provided to dispense hot water generated by heating purified water. The hot water dispensed through the hot water outlet 124 may be discharged to the outside of the water purifier 1 through the hot water dispenser 20 via the second flow path module 300. Here, the hot water may be generated in a hot water tank 150. The hot water tank 150 may accommodate purified water therein, and the purified water may be heated and generated as hot water inside the hot water tank 150. The purified water introduced into the hot water tank 150 may be heated by a heater. Also, the hot water tank 150 may have a form that is sealed from outside air and may be disposed in an upright form on the ground. For example, the hot water tank 150 may have a cylindrical shape.

In one embodiment of the present disclosure, the purified water outlet 121, the cold water tank 140, the cold water outlet 122, the cold water inlet 123, the hot water tank 150, and the hot water outlet 124 through which hot water is dispensed may be spaced a predetermined distance apart from the ground and disposed inside the housing 110. More specifically, the main body 100 may include an intermediate frame 120 positioned at a predetermined height from an installation surface and having the purified water outlet 121, the cold water outlet 122, the cold water inlet 123, and the hot water outlet 124 disposed thereon. The intermediate frame 120 may be fixed and coupled to the main body 100. The intermediate frame 120 may be fastened to the housing 110, and the cold water tank 140 and the hot water tank 150 may also be coupled onto the intermediate frame 120. Meanwhile, configurations for generating purified water (for example, one or more filters) may be disposed at a lower end inside the housing 110.

An upper portion of the housing 110 may be covered by a cover frame 130. The cover frame 130 may be fixed and coupled to the main body 100. For example, the cover frame 130 may be coupled to the upper portion of the housing 110. Meanwhile, the first flow path module 200 and the second flow path module 300 may be coupled to be attachable to and detachable from the cover frame 130. The cover frame 130 may have a cover body 131 disposed to cover the upper portion of the housing 110, and a first mounting hole 132 and a second mounting hole 133 provided to pass through the cover body 131 in the up-down direction. Here, the first flow path module 200 and the second flow path module 300 may be mounted on the main body 100 through the first mounting hole 132 and the second mounting hole 133, respectively. Also, the cover frame 130 may further have a first locking device 132a and a second locking device 133a configured to prevent detachment of the first flow path module 200 and the second flow path module 300 mounted through the first mounting hole 132 and the second mounting hole 133, respectively. The first locking device 132a may be rotatably coupled to an entry portion of the first mounting hole 132 of the cover body 131 and form a locking state or an unlocking state according to a rotary position. The second locking device 133a may be rotatably coupled to an entry portion of the second mounting hole 133 of the cover body 131 and form a locking state or an unlocking state according to a rotary position.

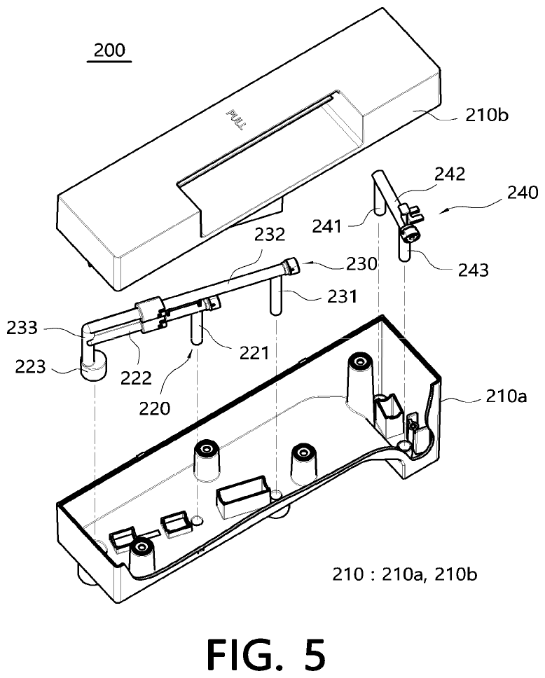

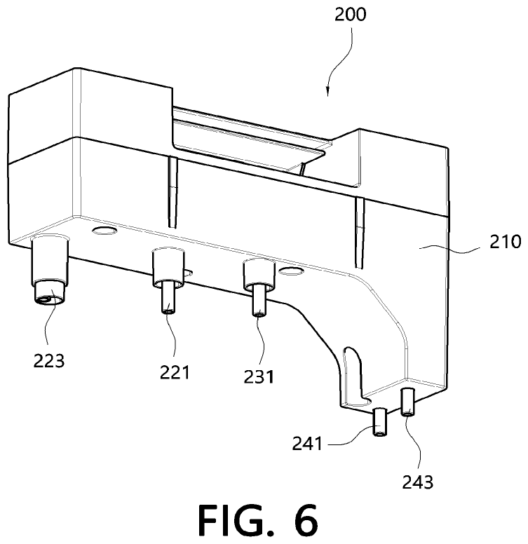

FIG. 5 is an exploded view of a first flow path module, and FIG. 6 is a perspective view of a coupling state of the first flow path module. Referring to FIGS. 5 and 6, the first flow path module 200 has a purified water dispensing pipe 220 connected to the purified water outlet 121 and a cold water dispensing pipe 230 connected to the cold water outlet 122 and is coupled to be attachable to and detachable from the main body 100. Also, the first flow path module 200 further has a cold water receiving pipe 240 connected to the cold water inlet 123 when the first flow path module 200 is mounted on the main body 100.

The purified water dispensing pipe 220 has a first inlet 221 connected to the purified water outlet 121 to receive purified water dispensed through the purified water outlet 121, a first flow portion 222 in which the purified water received through the first inlet 221 flows, and a first outlet 223 through which the purified water that has passed through the first flow portion 222 is dispensed. The purified water dispensed through the first outlet 223 may be discharged to the outside through the purified/cold water dispenser 10 of the main body 100. Also, the first inlet 221 and the first outlet 223 may extend in a first direction, and the first flow portion 222 may extend in a second direction perpendicular to the first direction. Here, the first direction may be the up-down direction, and the second direction may be the horizontal direction.

The cold water dispensing pipe 230 has a second inlet 231 connected to the cold water outlet 122 to receive cold water dispensed through the cold water outlet 122, a second flow portion 232 in which the cold water received through the second inlet 231 flows, and a second outlet 233 through which the cold water that has passed through the second flow portion 232 is dispensed. The cold water dispensed through the second outlet 233 may be discharged to the outside through the purified/cold water dispenser 10 of the main body 100. The second inlet 231 and the second outlet 233 may extend in a first direction, and the second flow portion 232 may extend in a second direction perpendicular to the first direction. Here, the first direction may be the up-down direction, and the second direction may be the horizontal direction. Also, the second outlet 233 may be connected to the first outlet 223 and form a single water dispensing flow path. The cold water dispensed through the second outlet 233 may be discharged to the outside of the cold water dispensing pipe 230 through the first outlet 223.

The cold water receiving pipe 240 forms a flow path through which purified water heading toward the cold water tank 140 passes. The cold water receiving pipe 240 has a third inlet 241 connected to the first cold water inlet 123a through which purified water generated by the purified water generator is dispensed, a third flow portion 242 in which the purified water introduced through the third inlet 241 flows, and a third outlet 243 through which the purified water that has passed through the third flow portion 242 is dispensed. That is, the purified water dispensed through the first cold water inlet 123a may be introduced through the third inlet 241, pass through the third flow portion 242, and then be dispensed through the third outlet 243 in order to be introduced into the cold water tank 140. Also, the third inlet 241 and the third outlet 243 may extend in a first direction, and the third flow portion 242 may extend in a second direction perpendicular to the first direction.

Here, the first direction may be the up-down direction, and the second direction may be the horizontal direction.

Meanwhile, the first flow path module 200 may have a first flow path case 210, and the purified water dispensing pipe 220, the cold water dispensing pipe 230, and the cold water receiving pipe 240 may be disposed inside the first flow path case 210. More specifically, the first flow path case 210 may include a first case main body 210a to which the purified water dispensing pipe 220, the cold water dispensing pipe 230, and the cold water receiving pipe 240 are fixed and coupled and a first case cover 210b configured to cover an upper portion of the first case main body 210a. Here, ends of the purified water dispensing pipe 220 (an end of the first inlet 221 and an end of the first outlet 223), an end of the second inlet 231 of the cold water dispensing pipe 230, an end of the third inlet 241 of the cold water receiving pipe 240, and an end of the third outlet 243 are exposed through one surface of the first flow path case 210, that is, the first case main body 210a. Here, the one surface of the first flow path case 210 may be a lower surface of the first flow path case 210.

In the above-described state in which the purified water dispensing pipe 220, the cold water dispensing pipe 230, and the cold water receiving pipe 240 are fixed and coupled to the inside of the first flow path case 210, the first flow path case 210 may be mounted on the first mounting hole 132 of the cover frame 130 to perform coupling between the first flow path module 200 and the main body 100. Here, the coupling between the first flow path module 200 and the main body 100 may be performed using a press-fit coupling method.

When an external force of a predetermined value or more is applied to the first flow path module 200 in a first direction, as the first flow path module 200 is coupled and fixed to the main body 100, the purified water outlet 121, the cold water outlet 122, and the cold water inlet 123 are connected to the purified water dispensing pipe 220, the cold water dispensing pipe 230, and the cold water receiving pipe 240, respectively. Also, when the external force of the predetermined value or more is applied to the first flow path module 200 in a second direction different from the first direction, as the coupling between the first flow path module 200 and the main body 100 is released, the connection between the purified water outlet 121 and the purified water dispensing pipe 220, the connection between the cold water outlet 122 and the cold water dispensing pipe 230, and the connection between the cold water inlet 123 and the cold water receiving pipe 240 are each released.

Here, in relation to the action of the external force, the first direction may be a downward direction, and the second direction may be an upward direction. For example, the purified water outlet 121, the cold water outlet 122, and the cold water inlet 123 may be open in the upward direction, and the first flow path module 200 may enter the main body 100 in the downward direction and be mounted thereon. Also, the predetermined value of the external force may be a range of a pulling force that can be provided by a user without the use of a tool. For example, the predetermined value of the external force may be a degree of the external force that is required for fastening using a press-fit method. Through such a coupling method, a user may easily replace flow paths related to dispensing of purified water and cold water without assistance.

Meanwhile, the first outlet 223 is a faucet that allows purified water and cold water to be dispensed to the outside of the water purifier 1. In other words, at the time of replacement of the first flow path module 200, instead of simply only the flow path being replaced, the faucet configured to discharge cold water and purified water to the outside of the water purifier 1 is also replaced. Also, as illustrated in FIG. 6, the first outlet 223 of the first flow path module 200 is exposed through one surface of the first flow path case 210. Accordingly, at the time of mounting of the first flow path module 200, hygiene management of the faucet may also be effectively performed.

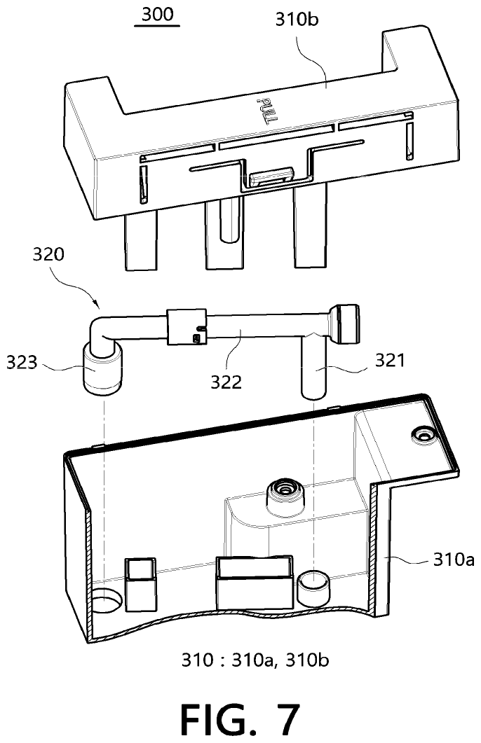

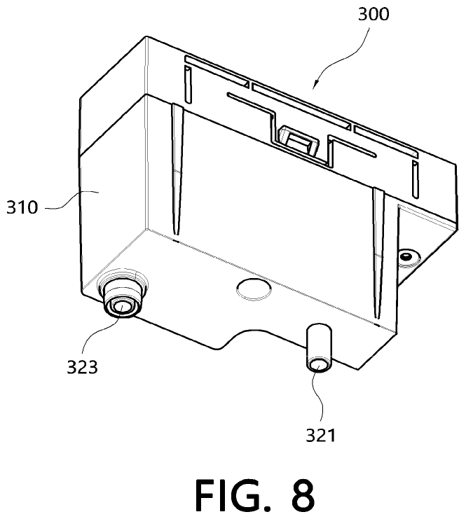

FIG. 7 is an exploded view of a second flow path module, and FIG. 8 is a perspective view of a coupling state of the second flow path module. Referring to FIGS. 7 and 8, the second flow path module 300 has a hot water dispensing pipe 320 connected to the hot water outlet 124 and is coupled to be attachable to and detachable from the main body 100.

The hot water dispensing pipe 320 has a fourth inlet 321 connected to the hot water outlet 124 to receive hot water dispensed through the hot water outlet 124, a fourth flow portion 322 in which the hot water received through the fourth inlet 321 flows, and a fourth outlet 323 through which the hot water that has passed through the fourth flow portion 322 is dispensed. The hot water dispensed through the fourth outlet 323 may be discharged to the outside through the hot water dispenser 20 of the main body 100. Also, the fourth inlet 321 and the fourth outlet 323 may extend in a first direction, and the fourth flow portion 322 may extend in a second direction perpendicular to the first direction. Here, the first direction may be the up-down direction, and the second direction may be the horizontal direction.

Meanwhile, the second flow path module 300 may have a second flow path case 310, and the hot water dispensing pipe 320 may be disposed inside the second flow path case 310. More specifically, the second flow path case 310 may include a second case main body 310a to which the hot water dispensing pipe 320 is fixed and coupled and a second case cover 310b configured to cover an upper portion of the second case main body 310a. Here, ends of the hot water dispensing pipe 320, that is, an end of the fourth inlet 321 and an end of the fourth outlet 323, are exposed through one surface of the second flow path case 310, that is, the second case main body 310a. Here, the one surface of the second flow path case 310 may be a lower surface of the second flow path case 310.

In the above-described state in which the hot water dispensing pipe 320 is fixed and coupled to the inside of the second flow path case 310, the second flow path case 310 may be mounted on the second mounting hole 133 of the cover frame 130 to perform coupling between the second flow path module 300 and the main body 100. Here, the coupling between the second flow path module 300 and the main body 100 may be performed using the press-fit coupling method.

When an external force of a predetermined value or more is applied to the second flow path module 300 in a first direction, as the second flow path module 300 is coupled and fixed to the main body 100, the hot water outlet 124 is connected to the hot water dispensing pipe 320. Also, when the external force of the predetermined value or more is applied to the second flow path module 300 in a second direction different from the first direction, as the coupling between the second flow path module 300 and the main body 100 is released, the connection between the hot water outlet 124 and the hot water dispensing pipe 320 is released.

Here, in relation to the action of the external force, the first direction may be a downward direction, and the second direction may be an upward direction. For example, the hot water outlet 124 may be open in the upward direction, and the second flow path module 300 may enter the main body 100 in the downward direction and be mounted thereon. Also, the predetermined value of the external force may be a range of a pulling force that can be provided by a user without the use of a tool. For example, the predetermined value of the external force may be a degree of the external force that is required for fastening using a press-fit method. Through such a coupling method, a user may easily replace flow paths related to dispensing of hot water without assistance.

Meanwhile, the fourth outlet 323 is a faucet that allows hot water to be dispensed to the outside of the water purifier 1. In other words, at the time of replacement of the second flow path module 300, instead of simply only the flow path being replaced, the faucet configured to discharge hot water to the outside of the water purifier 1 is also replaced. Also, as illustrated in FIG. 8, the fourth outlet 323 of the second flow path module 300 is exposed through one surface of the second flow path case 310. Accordingly, at the time of mounting of the second flow path module 300, hygiene management of the faucet may also be effectively performed.

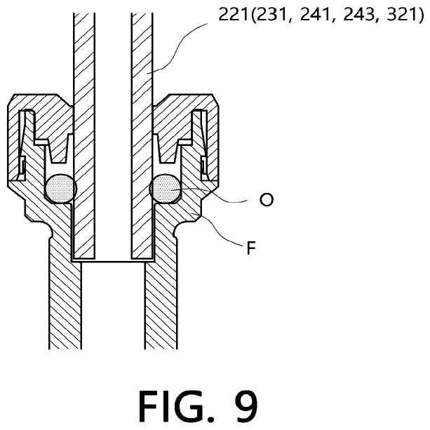

FIG. 9 is a longitudinal cross-sectional view illustrating a connection state of an end of a pipe and a fitting.

Referring to FIG. 9, the end of each of the purified water outlet 121, the cold water outlet 122, the cold water inlet 123, and the hot water outlet 124 may be provided as an opening, and a fitting F that allows the purified water dispensing pipe 220 to be inserted, seated, and connected, a fitting F that allows the cold water dispensing pipe 230 to be inserted, seated, and connected, a fitting F that allows the cold water receiving pipe 240 to be inserted, seated, and connected, and a fitting F that allows the hot water dispensing pipe 320 to be inserted, seated, and connected may be coupled to the end of the purified water outlet 121, the end of the cold water outlet 122, the end of the cold water inlet 123, and the end of the hot water outlet 124, respectively. In other words, the ends of the first inlet 221, the second inlet 231, the third inlet 241, the third outlet 243, and the fourth outlet 323 may be coupled to the purified water outlet 121, the cold water outlet 122, the cold water inlet 123, and the hot water outlet 124, respectively, through the fittings F. Also, inside the fittings F, an O-ring for securing watertightness may be disposed at the end of each of the first inlet 221, the second inlet 231, the third inlet 241, the third outlet 243, and the fourth outlet 323.

Embodiments of the present disclosure have been described above, but the spirit of the present disclosure is not limited by the embodiments presented herein, and those of ordinary skill in the art who understand the spirit of the present disclosure may easily propose other embodiments by adding other components, changing components, or omitting components within the scope of the same spirit. However, such embodiments also belong to the scope of the spirit of the present disclosure.

1. A water purifier comprising:
a main body configured to filter raw water to generate purified water, cool the purified water to generate cold water, and heat the purified water to generate hot water and having a purified water outlet through which the purified water is dispensed, a cold water outlet through which the cold water is dispensed, and a hot water outlet through which the hot water is dispensed;
a first flow path module coupled to be attachable to and detachable from the main body and having a purified water dispensing pipe connected to the purified water outlet and a cold water dispensing pipe connected to the cold water outlet; and
a second flow path module coupled to be attachable to and detachable from the main body and having a hot water dispensing pipe connected to the hot water outlet,
wherein, when an external force of a predetermined value or more is applied to the first flow path module in a first direction, as the first flow path module is coupled and fixed to the main body, the purified water outlet and the cold water outlet are connected to the purified water dispensing pipe and the cold water dispensing pipe, respectively,
when the external force of the predetermined value or more is applied to the first flow path module in a second direction different from the first direction, as coupling between the first flow path module and the main body is released, connection between the purified water outlet and the purified water dispensing pipe and connection between the cold water outlet and the cold water dispensing pipe are released,
when the external force of the predetermined value or more is applied to the second flow path module in the first direction, as the second flow path module is coupled and fixed to the main body, the hot water dispensing pipe is connected to the hot water outlet, and
when the external force of the predetermined value or more is applied to the second flow path module in the second direction, as coupling between the second flow path module and the main body is released, connection between the hot water outlet and the hot water dispensing pipe is released.

2. The water purifier of claim 1, wherein:
the main body further has a cold water tank in which the purified water is cooled and a cold water inlet through which the purified water heading to the cold water tank is dispensed; and
the first flow path module further has a cold water receiving pipe connected to the cold water inlet when the first flow path module is mounted on the main body.

3. The water purifier of claim 1, wherein the purified water outlet, the cold water outlet, and the hot water outlet are open in an upward direction, and the first flow path module and the second flow path module enter the main body in a downward direction and are mounted thereon.

4. The water purifier of claim 3, wherein:
the main body further has an intermediate frame positioned at a predetermined height from an installation surface and on which the purified water outlet, the cold water outlet, and the hot water outlet are disposed and a cover frame disposed at an upper side of the intermediate frame; and
the first flow path module and the second flow path module are mounted on the main body through a first mounting hole and a second mounting hole provided to pass through the cover frame in an up-down direction.

5. The water purifier of claim 4, wherein the intermediate frame and the cover frame are fixed and coupled to the main body.

6. The water purifier of claim 1, wherein the first flow path module further has a first flow path case, the purified water dispensing pipe and the cold water dispensing pipe are disposed inside the first flow path case, and an end of the purified water dispensing pipe and an end of the cold water dispensing pipe are exposed through one surface of the first flow path case.

7. The water purifier of claim 1, wherein the second flow path module further has a second flow path case, the hot water dispensing pipe is disposed inside the second flow path case, and an end of the hot water dispensing pipe is exposed through one surface of the second flow path case.

8. The water purifier of claim 1, wherein:
the end of each of the purified water outlet, the cold water outlet, and the hot water outlet is provided as an opening; and
a fitting that allows the purified water dispensing pipe to be inserted, seated, and connected, a fitting that allows the cold water dispensing pipe to be inserted, seated, and connected, and a fitting that allows the hot water dispensing pipe to be inserted, seated, and connected are coupled to the end of the purified water outlet, the end of the cold water outlet, and the end of the hot water outlet, respectively.
